(19) United States
(12) Patent Application Publication
(10) Pub. No.: US 2021/0233166 A1
(43) Pub. Date: Jul. 29, 2021

(54) System and Method Of Lender, Borrower, and Employee Driven Enrollment

(71) Applicant: David B. Coulter, Tustin, CA (US)

(72) Inventor: David B. Coulter, Tustin, CA (US)

(21) Appl. No.: 17/161,461

(22) Filed: Jan. 28, 2021

Related U.S. Application Data
(60) Provisional application No. 62/966,950, filed on Jan. 28, 2020.

(51) Int. Cl. G06Q 40/02; G06Q 10/10; G06F 9/451; G06F 3/0482; A63F 13/792

(52) U.S. Cl. CPC G06Q 40/025; G06Q 10/105; A63F 13/792; G06F 3/0482; G06F 9/451

(57) ABSTRACT

Systems and processes for the gamification of data, including providing scenarios and actionable elements to execute a preferred scenario. Embodiments include providing access to a plurality of users such as a lender and a borrower, who can then collaborate to agree on a financial model to achieve a future credit score. The lender can then provide a loan based on the future credit score contingent on correct implementation of the financial model. The system can monitor changes in the borrower's credit score to confirm implementation, or reassess the financial model. The borrower and/or lender can share a summary of the financial model, and other details with non-users of the system or non-subscriber lenders of the system. Demonstrated results, tailored models, and trust in the recommender motivates the user and/or non-subscriber lender to enroll. Additional benefits can be achieved through bulk underwriting of common groups through driving lender and borrower enrollment.

### RELATED APPLICATIONS

This application claims the benefit of priority to U.S. Provisional Application No. 62/966,950, filed Jan. 28, 2020, which is incorporated by reference in its entirety into this application.

The following patents and publications are related to the subject matter of this application and are incorporated by reference in their entireties into this application: U.S. Pat. Nos. 7,818,228, 7,877,304, 8,285,613, US 2011/0166988, US 2020/0074546, and US 2018/0308317.

### SUMMARY

Disclosed herein is a method for enrolling users to a system including, responsive to information received from a first user, generating a first gamified user interface for, i) depicting a first credit score and information associated with a second user, and ii) selecting a second credit score, wherein the first gamified user interface includes a digitally rendered modifiable image, conducting analytics on the information associated with the second user in accordance with one or more predetermined rule sets to generate a credit modification model, wherein the information associated with the second user includes personally identifiable information or financial data, wherein conducting analytics includes determination of operations of the credit modification model to modify a credit score associated with the second user from the first credit score to the second credit score, generating a second gamified user interface depicting the second credit score, and displaying a proposed change to the information associated with the second user, responsive to detecting a selection of an actionable display element rendered as part of the second gamified user interface, transmitting the one or more messages to a destination, the transmission of the message resulting in an implementation of the operations of the credit modification model to modify the credit score associated with the second user from the first credit score to the second credit score, and conducting analytics on a change in the credit score associated with the second user over time to provide a progress report.

In some embodiments, the method further includes providing access to the gamified user interface to the second user, and sending and receiving information from one of the first user or the second user that causes generating a second gamified user interface. In some embodiments, the method further includes generating a summary report that includes one of the first credit score, the second credit score, the credit modification model, or the progress report. In some embodiments, the method further includes removing any personally identifiable information from the summary report and providing a share link to one of the first user or the second user to share the summary report with a third user. In some embodiments, the first user is a first lender, the second user is a first borrower, and the third user is one of a second borrower or a second lender. In some embodiments, the method further includes providing a second share link to the third user to provide access to the third user to generate a third gamified user interface, including a third credit modification model, using information associated with the third user. In some embodiments, retrieving information from one or more lenders and information of one or more loans and conducting analytics to match a loan with the third credit modification model.

In some embodiments, the method further includes conducting analytics on the information associated with the second user to determine membership to a group, aggregating information from one or more members of the group to create a group summary report, and providing access to the group summary report to one of an underwriter, a lender, or an employer of the group members. In some embodiments, information from the one or more members of the group includes one of a first credit score, a second credit score, a credit modification model, or a progress report. In some embodiments, the method further includes responsive to detecting a selection of an actionable display element rendered as part of the second gamified user interface transmitting the one or more messages to a destination further includes initiating a loan for the second user based on the second credit score, the loan being funded when the second user achieves the second credit score.

Also disclosed is a non-transitory computer readable medium which, when read by a processor, causes the processor to execute, a gamified scenario logic configured to receive information from a first user and to generate a first gamified user interface including depicting a first credit score and information associated with a second user, and selecting a second credit score, wherein the first gamified user interface includes a digitally rendered modifiable image, a financial model logic configured to conduct analytics on the information associated with the second user in accordance with one or more predetermined rule sets to generate a credit modification model, wherein the information associated with the second user includes personally identifiable information or financial data, and wherein conducting analytics includes determination of operations of the credit modification model to modify a credit score associated with the second user from the first credit score to the second credit score, and a progress report logic configured to conduct analytics on a change in the credit score associated with the second user over time to provide a progress report.

In some embodiments, the gamified scenario logic is further configured to provide access to the gamified user interface to the second user, and send and receive information from one of the first user or the second user that causes generating a second gamified user interface. In some embodiments, the non-transitory computer readable medium further includes a summary report logic configured to generate a summary report that includes one of the first credit score, the second credit score, the credit modification model, or the progress report. In some embodiments, the summary report logic is further configured to remove any personally identifiable information from the summary report and provide a share link to one of the first user or the second user to share the summary report with a third user. In some embodiments, the first user is a first lender, the second user is a first borrower, and the third user is one of a second borrower or a second lender.

In some embodiments, the summary report logic is further configured to provide a second share link to the third user to provide access to the third user to generate a third gamified user interface, including a third credit modification model, using information associated with the third user. In some embodiments, the non-transitory computer readable medium further includes a lender selection logic configured to retrieve information from one or more lenders and information of one or more loans and conduct analytics to match a loan with the third credit modification model. In some embodiments, the non-transitory computer readable medium further includes a group selection logic configured to conduct analytics on the information associated with the second user to determine membership to a group, aggregating information from one or more members of the group to create a group summary report, and providing access to the group summary report to one of an underwriter, a lender, or an employer of the group members.

In some embodiments, information from the one or more members of the group includes one of a first credit score, a second credit score, a credit modification model, or a progress report. In some embodiments, the gamified scenario logic is configured to detect selection of an actionable display element rendered as part of the first gamified user interface and transmit one or more messages to a destination, the one or more messages includes initiating a loan for the second user based on the second credit score, the loan being funded when the second user achieves the second credit score.

Also disclosed is a network device including a processor, and memory communicatively coupled to the processor, the memory including machine readable instructions that when executed by the processor, cause the processor to execute, i) a gamified scenario logic configured to receive information from a first user and to generate a first gamified user interface including depicting a first credit score and information associated with a second user, and selecting a second credit score, wherein the first gamified user interface includes a digitally rendered modifiable image, ii) a financial model logic configured to conduct analytics on the information associated with the second user in accordance with one or more predetermined rule sets to generate a credit modification model, wherein the information associated with the second user includes personally identifiable information or financial data, wherein conducting analytics includes determination of operations of the credit modification model to modify a credit score associated with the second user from the first credit score to the second credit score, and iii) a progress report logic configured to conduct analytics on a change in the credit score associated with the second user over time to provide a progress report.

In some embodiments, the gamified scenario logic is configured to detect selection of an actionable display element rendered as part of the first gamified user interface and transmit one or more messages to a destination, the one or more messages includes initiating a loan for the second user based on the second credit score, the loan being funded when the second user achieves the second credit score.

### BRIEF DESCRIPTION OF THE DRAWINGS

To further clarify embodiments of the disclosure, a more particular description will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary architecture of a system, in accordance with embodiments disclosed herein.

FIG. 2 illustrates an exemplary logical system architecture of a system, in accordance with embodiments disclosed herein.

FIG. 3 illustrates an exemplary gamified scenario, in accordance with embodiments disclosed herein.

FIG. 4 illustrates an exemplary summary report including a progress report, in accordance with embodiments disclosed herein.

FIG. 5 illustrates an exemplary enrollment process, in accordance with embodiments disclosed herein.

FIG. 6 illustrates an exemplary enrollment process, in accordance with embodiments disclosed herein.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

### Terminology

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “a first actionable element,” may be made. However, the specific numeric reference should not be interpreted as a literal sequential order but rather interpreted that the “first actionable element” is different than a “second actionable element.” Thus, the specific details set forth are merely exemplary. The specific details may be varied from and still be contemplated to be within the spirit and scope of the present disclosure. The term “coupled” is defined as meaning connected either directly to the component or indirectly to the component through another component, where the connection may enable communications between these components.

As used herein, the term “communication” generally refers to related data that is received, transmitted, or exchanged within a communication session. The data may include a plurality of packets, where a “packet” broadly refers to a series of bits or bytes having a prescribed format. Alternatively, the data may include a collection of data that may take the form of an individual or a number of packets carrying related payloads, e.g., a single webpage received over a network. Further, as used herein, the terms “about,” “approximately,” or “substantially” for any numerical values or ranges indicate a suitable dimensional tolerance that allows the part or collection of components to function for its intended purpose as described herein.

In the following description, certain terminology is used to describe features of the invention. For example, in certain situations, the term “logic” is representative of hardware, firmware and/or software that is configured to perform one or more functions. As hardware, logic may include circuitry having data processing or storage functionality. Examples of such circuitry may include, but are not limited or restricted to a microprocessor, one or more processor cores, a programmable gate array, a microcontroller, a controller, an application specific integrated circuit (“ASIC”), wireless receiver, transmitter and/or transceiver circuitry, semiconductor memory, or combinatorial logic.

Alternatively, logic may be software, such as executable code in the form of an executable application, an Application Programming Interface (API), a subroutine, a function, a procedure, an applet, a servlet, a routine, source code, object code, a shared library/dynamic load library, or one or more instructions. The software may be stored in any type of a suitable non-transitory storage medium, or transitory storage medium (e.g., electrical, optical, acoustical or other form of propagated signals such as carrier waves, infrared signals, or digital signals). Examples of a non-transitory storage medium may include, but are not limited or restricted to a programmable circuit; semiconductor memory; non-persistent storage such as volatile memory (e.g., any type of random access memory “RAM”); or persistent storage such as non-volatile memory (e.g., read-only memory “ROM,” power-backed RAM, flash memory, phase-change memory, etc.), a solid-state drive, hard disk drive, an optical disc drive, or a portable memory device. As firmware, the executable code may be stored in persistent storage.

The term “computing device” may be construed as electronics with data processing capabilities and/or a network interface capabilities, such as network connectivity to a physical or virtual network such as a public network (e.g., Internet), a private network (e.g., a wireless data telecommunication network, a local area network “LAN”, etc.), a public cloud network, a virtual private cloud, of the like. Examples of a computing device may include, but are not limited or restricted to, the following: a server, an endpoint device (e.g., a laptop, a smartphone, a “wearable” device, a smartwatch, a tablet, a desktop or laptop computer, a netbook, or any general-purpose or special-purpose, user-controlled electronic device); a mainframe; a router; or the like.

The term “network” may include a public and/or private network based on wired or wireless interconnects and in a centralized or decentralized configuration. The networks may include, but are not limited or restricted to a Local Area Network (LAN), a Wireless Local Area Network (WLAN), a Virtual Private Network (VPN), intranet, internet, ‘cloud’ based network, or similar network configurations.

A “message” generally refers to information transmitted in one or more electrical signals that collectively represent electrically stored data in a prescribed format. Each message may be in the form of one or more packets, frames, HTTP-based transmissions, or any other series of bits having the prescribed format.

The term “computerized” generally represents that any corresponding operations are conducted by hardware in combination with software and/or firmware.

The term, a “line of credit” or “account” may include any rolling credit account, credit card account, a personal line of credit, personal loans, commercial loans, secured or unsecured loans, cash advances, equity lines of credit (“ELOC”), or the like. The term “credit limit” of an account may be construed as the total amount of credit allowed for the account. The “credit usage” of an account may be construed as the amount of credit limit that has been borrowed. The term “credit score” may be construed as an indicator of the credit worthiness of a particular individual, which may be represented by a numerical credit score. The term “credit worthiness” is a level of risk associated with a user from the perspective of a lender. The term “credit rating” may be construed as a grouping to which a user is assigned i.e. “fair,” “good,” “exceptional,” etc.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition may occur only when a combination of elements, functions, steps or acts are in some way inherently mutually exclusive.

### Exemplary System Architecture

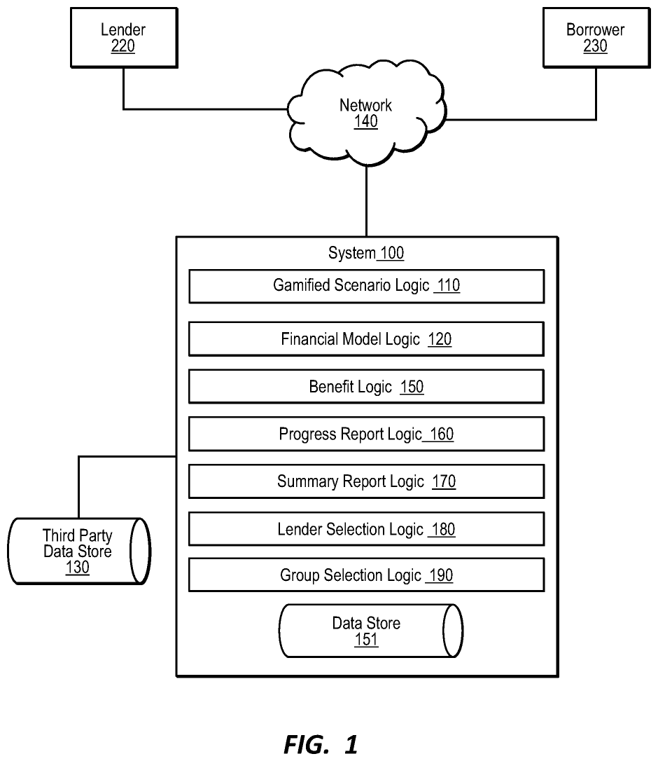

FIG. 1 shows an exemplary architecture of a system 100. The system 100 may include one or more computing devices, such as a server, which communicates with other computing devices, such as, for example, a first user 220 operating as a mortgage broker or lender and a second user 230 operating as a borrower. Each of the computing devices 100, 220 and 230 may be communicatively coupled, either directly or indirectly, through a network 140. As shown, the system 100 may be deployed as a physical server, including a processor and a non-transitory storage medium (e.g., memory) configured to store a gamified scenario logic 110, a financial model logic 120, a benefit logic 150, a data store 151, a progress report logic 160, a summary report logic 170, a lender selection logic 180, and a group selection logic 190. Alternatively, the system 100 may be deployed as a virtual server, namely software deployed within a public or private cloud network and operating as a physical server.

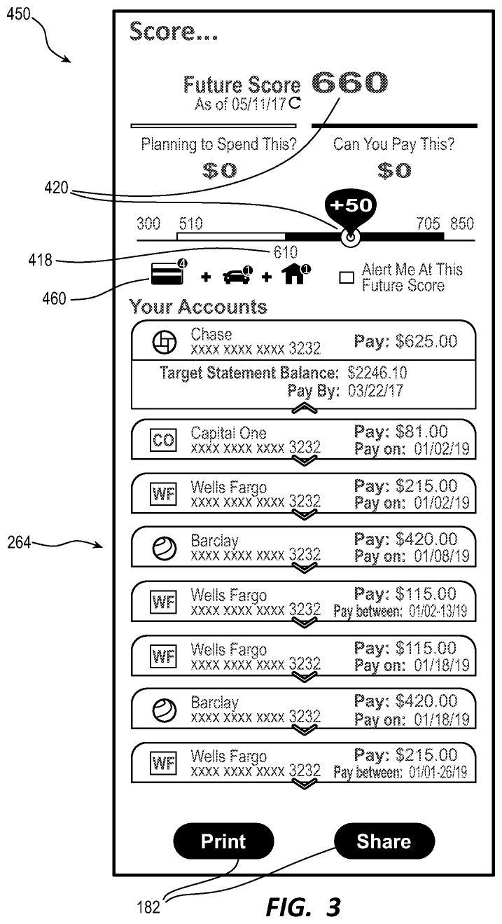

Herein, according to one embodiment of the disclosure, the gamified scenario logic 110, as will be discussed in more detail herein, may include logic configured to perform functions to generate a gamified scenario 450 (FIG. 3). The gamified scenario 450 is a dynamically updatable graphical interface that includes aggregated information about the borrower 230, including some or all of a current credit score 418 for the borrower 230, a future credit score 420 for the borrower 230, and/or a financial model 264, e.g. a credit modification model. Further details and embodiments of which can be found in U.S. Patent Publication 2018/0308317 and U.S. Patent Publication 2020/0074546 which are each incorporated by reference in its entirety.

The financial model logic 120, as will be discussed in more detail herein, may include logic configured to perform functions to generate a financial model 264, e.g. a credit modification model. The financial model 264 includes details of actions to be carried out, the order to implement the actions, and the time windows within which to implement the actions. For example, as shown in FIG. 3, the financial model 264 may include one or more accounts to be paid, the order with which they are to be paid, the amount to be paid to each account, and/or the time window within which the amount is to be paid in order for the future score to be achieved within a predetermined time period, e.g. 30 days. According to one embodiment of the disclosure, the financial model logic 120 may be configured to operate in an iterative manner, prompted by queries or automated based on one or more commands based on the lender 220 commencing processing of a loan based on the future (e.g., anticipated) credit score of the borrower based on timely completion of the details of actions. The iterative operations may be automated to confirm credit score progression as outlined by the financial model 264 or to provide a revised financial model, with revised details of action to achieve the future credit score (or another credit score that would enable the borrower to secure similar loan terms, etc.) as feedback for completed or failed actions by the borrower 230 as outlined by the financial model 264.

The benefit logic 150, as will be discussed in more detail herein, may include logic configured to perform functions to retrieve different goods and services provided by one or more third parties that are available when a given credit score is reached. As an illustrative example, the benefit logic 150 can retrieve either a current credit score 418 and/or a future credit score 420 and match associated goods and services that are available.

The progress report logic 160, as will be discussed in more detail herein, may include logic configured to perform functions to provide a progress report 260. According to one embodiment of the disclosure, the progress report 260 may include information detailing a change in a borrowers credit score over time and extrapolating expected progress towards a targeted, future credit score 420. It is contemplated that the progress report logic 160 may include milestones that are computed based on certain actions conducted in accordance with the financial model 264, which may prompt the financial model logic 120 to generate feedback messages regarding progress to the lender 220 upon reaching these milestones. This iterative progress is a practical application that reduces lender risk where the lender 220 is underwriting loans based on future credit scores.

The summary report logic 170, as will be discussed in more detail herein, may include logic configured to perform functions to provide a summary report 270 including details of a current credit score 418, a future credit score 420, a financial model 264, a progress report 260, or any combination thereof. Optionally, the summary report logic 170 can remove any personally identifiable information (P.I.I.) so that the summary report 270 can be shared with other users or non-users of the system 100.

The lender selection logic 180, as will be discussed in more detail herein, may include logic configured to perform functions of retrieving information for one or more lenders 220, and details of one or more loans (e.g. interest rates, fees, costs, taxes, monthly payments, etc.) termed “loan rates,” offered by the lender 220, and select the lender 220 and/or loan rate that is beneficial to the financial model 264.

The group selection logic 190, as will be discussed in more detail herein, may include logic configured to perform functions of analyzing details of one or more users and determining various groupings to which the one or more users belong. Exemplary groupings can include, employer, job type, industry, geographic area, socio-demographic group, and the like.

The data store 151, as will be discussed in more detail herein, may operate as persistent storage, such as a database configured to store information from, and provide information to, the gamified scenario logic 110, the financial model logic 120, the benefit logic 150, the data store 151, the progress report logic 160, the summary report logic 170, the lender selection logic 180, the group selection logic 190, or a combination thereof. It will be appreciated other logic or databases can be communicatively coupled, either directly or indirectly, with the data store 151, without limitation.

In an embodiment, the logic described herein may rely on heuristics, machine learning, artificial intelligence (A.I.), neural networks, or other data processing techniques to perform the described functionality.

### Exemplary Logical Representation of the System Architecture

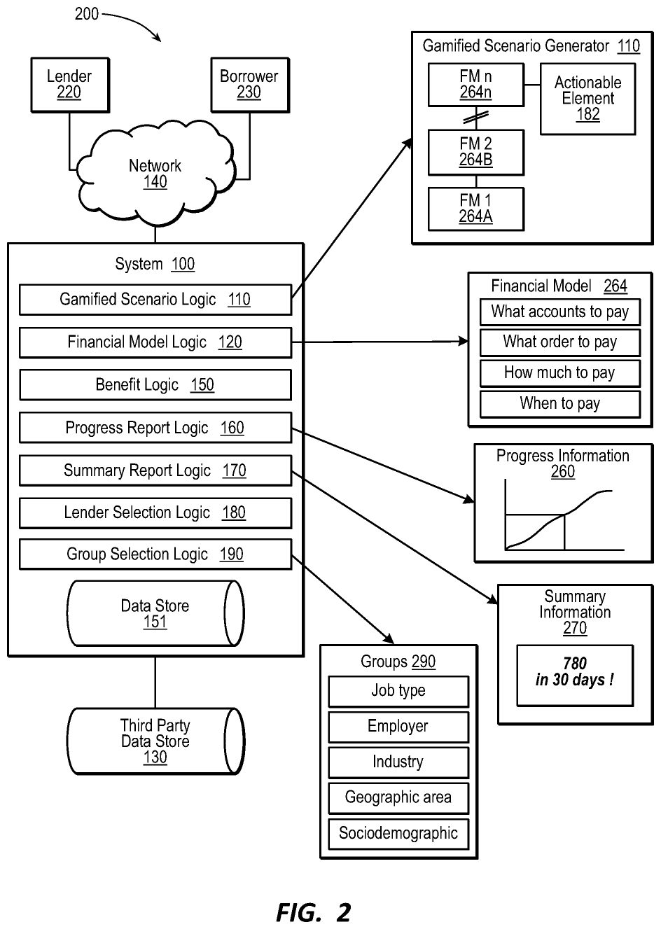

FIG. 2 shows an exemplary logic architecture 200 for the system 100. The lender 220 can subscribe to the system 100 and optionally pay a subscription fee or one-time access fee. The details of the lender 220 (e.g., name, source email address, etc.) can be stored by the data store 151. The lender 220 can be prompted for information about a potential borrower 230. The lender 220 can provide identifying information about the potential borrower 230, e.g. personal information, P.I.I., social security number (S.S.N.), or the like, which can be stored in data store 151.

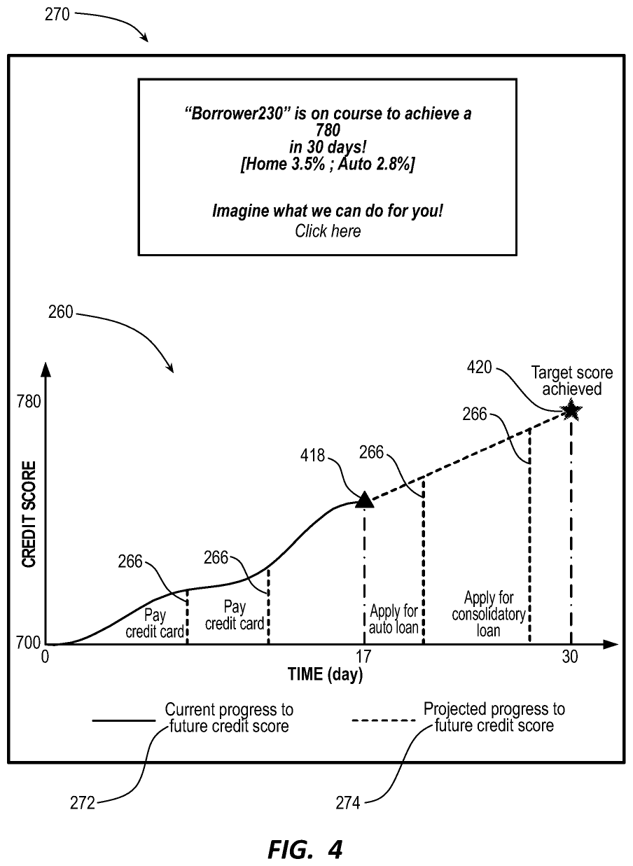

The lender 220 can send a request to the system 100, to generate a gamified scenario 450 for the borrower 230. On receiving the request, the gamified scenario logic 110 can retrieve information and generate a gamified scenario 450, which can be a dynamically updatable interface, and includes the current credit score 418, the future credit score 420 and/or a financial model 264 as shown in FIGS. 3-4. The gamified scenario logic 110 can retrieve information from internal databases, e.g. data store 151, or external databases e.g. from a third party data store 130 such as financial institutions, credit bureau, or the like. Optionally, the lender 220 can be prompted to upload information to the system 100 via a gamified scenario 450.

The financial model logic 120 generates a financial model 264, e.g. FM-1 264A, which includes instructions of how to achieve the future credit score 420 of the gamified scenario 450. For example, the financial model 264 may include what actions to take (e.g. accounts to pay, accounts to open), which accounts to pay, what order to pay the accounts in, how much to pay, when to carry out the action(s), or the like.

The lender 220 can provide access to the gamified scenario 450 to the borrower 230, by way of the network 140. The lender 220 and/or the borrower 230 can modify the gamified scenario 450, for example by amending a future credit score 420. Optionally, the borrower 230 can be prompted to upload information to the system 100 via the gamified scenario 450.

When a request to modify the gamified scenario 450 is received by the system 100, e.g. requesting a different future credit score, the financial model logic 120 provides a new financial model, e.g. FM-2 264B. The lender 220 and/or the borrower 230 can send further requests to modify the future credit score 420, until a financial model is agreed upon by both the lender 220 and the borrower 230, e.g. FM-n 264n.

Optionally, the lender 220 and/or the borrower 230 can send requests to modify one or more features of the financial model 264 via the gamified scenario 450. For example modifying the number or types of accounts included in the financial model, the amounts to be paid, and the like. In response to these requests, the gamified scenario logic 110 provides an updated future credit score 420. In an embodiment, in response to the requests to modify one or more features of the financial model 264, the gamified scenario logic 110 can maintain the future credit score 420 by modifying different features of the financial model 264.

For example, a lender 220 may have a current credit score 418 of 700 pts. and set a future credit score 420 to 780 pts. The financial model logic 120 can provide a financial model, e.g. FM-2 264B detailing what accounts to pay, in which order, how much to pay and at which time, in order to achieve the future credit score 420 within a predetermined time frame. The lender 220 or the borrower 230 may further modify the financial model 264, e.g. to remove an account from the financial model. In response to which the gamified scenario logic 110 can provide an updated future credit score 420, i.e. different from 780 pts. Alternatively, the gamified scenario logic 110 can maintain the future credit score 420 (i.e. 780 pts.) and modify actions of the financial model in order to still achieve the future credit score 420 within the predetermined time frame, (i.e. add or remove other accounts, modify the amounts, adjust the time or order with which the accounts are paid, etc.)

The gamified scenario can further include an actionable element 182 that, once actioned, sends instructions to the borrower 230 to implement the financial model 264. In an embodiment, the actionable element 182 causes the system 100 to autonomously implement the financial model 264 by sending instructions to one or more third parties, such as account holders, banks, financial institutions, etc. In an embodiment, the actionable element 182 causes the system 100 to share a progress report 260 and/or a summary report 270, including details of the financial model, with other users or non-users of the system, as described in more detail herein.

Advantageously, the actionable element 182 causing the system 100 to autonomously implement the financial model 264 streamlines the amount of work for the lender 220 and/or the borrower 230. Each financial model can include multiple and complex instructions including what accounts to pay, how much to pay, what order to pay them in, and/or when to pay them in order to achieve the future credit score. This would otherwise require an extensive amount of work to co-ordinate and implement the instructions, on time, in the correct order, to achieve the future credit score. Optionally, these instructions would need to be implemented within a time frame that would be impossible to carry out “by hand” by an individual. Advantageously, the system 100 can co-ordinate and implement the instructions of the financial model 264 correctly and in a timely manner.

The system 100 can further include the benefit logic 150. The benefit logic 150 retrieves the current credit score 418 and the future credit score 420 from the gamified scenario 450. The benefit logic 150 retrieves information about various goods or services that are available, based on the different credit scores. The benefit logic 150 can then provide benefits 460, e.g. micro-ads that link different goods or services with the current credit score 418 and/or the future credit score 420. These can be displayed as part of the gamified scenario 450 and are dynamically updateable depending on changes to the current or future credit scores. Further details of these benefits, micro-ads, or the like, can be found in U.S. Patent Publication 2018/0308317 and U.S. Patent Publication 2020/0074546 which are incorporated by reference in their entirety, herein.

The progress report logic 160 can be triggered to create a progress report 260 and provide feedback information to the financial model logic 120 to prompt iterative generation to confirm a future credit score based on completed activities by the user. The progress report logic 160 can be triggered based on a time interval trigger, an action trigger, or a combination thereof. When triggered, the progress report logic 160 retrieves a future credit score 420 as defined by the gamified scenario 450 and a credit score of the borrower when the gamified scenario was implemented, (i.e. when actionable element 182 was actioned). The progress report logic 160 also retrieves a current credit score 418, and one or more credit scores between the time when the gamified scenario was implemented and present. The progress report logic 160 can then determine a change in credit score over time and extrapolate a progress towards the future credit score. The progress report logic 160 can then determine if the financial model is being implemented correctly and if the financial model is having the predicted effect of achieving the future credit score 420.

The summary report logic 170 can retrieve details about the gamified scenario, the financial model 264, the progress report 260, details of the borrower 230, details of the lender 220, or combinations thereof, and prepare a summary report 270. Further, the summary report logic 170 can remove any personally identifiable information (P.I.I.) before sharing the summary report 270 with one or more users or non-users of the system 100.

The lender selection logic 180 can retrieve details about one or more lenders 220 as well as details of one or more loans offered by the one or more lenders. In an embodiment, the lender selection logic 180 can send requests to one or more lenders requesting details of loans offered match one or more lenders 220 with the borrower 230, as described in more detail herein.

The group selection logic 190 can retrieve details about one or more borrowers 230 and identify one or more groups that the borrower 230 identifies with. Exemplary groups can include, employer, job type, industry, geographic area, socio-demographic group, or the like.

### Exemplary Gamified Scenario Plan Development

FIG. 3 shows an exemplary embodiment of the gamified scenario 450, including the current credit score 418, the future credit score 420, and the financial model 264. The gamified scenario 450 may further include benefits 460, e.g. micro-ads associated with the current credit score 418, future credit score 420, or combinations thereof. As described herein, when triggered, the gamified scenario logic 110 queries the data store 151 and/or the third party data store 130, to retrieve information to generate the gamified scenario 450. The third party data store 130 may include, for example, credit reports from a credit bureau, financial information from banks, or the like. Optionally the gamified scenario logic 110 may also prompt for additional information from the borrower 230, or the lender 220.

The gamified scenario logic 110 also triggers the financial model logic 120 to generate a financial model 264 for the borrower 230 to achieve the future credit score 420. The financial model 264 includes details of actions to be carried out, the order to implement the actions, and the time windows to implement the actions in order for the future score 420 to be achieved within a predetermined time period, e.g. 30 days, although greater or lesser time windows are also contemplated. For example, as shown, the financial model 264 may include the accounts to be paid, the order with which they are to be paid, the amounts to be paid for each account, and/or the time window within which the amounts are to be paid.

In an embodiment, the gamified scenario logic 110 can rely on heuristics, machine learning, artificial intelligence (A.I.), neural networks, or other data processing techniques to generate a financial model 264. This can include determining trends from previous financial models and resulting future credit scores achieved, from the user or other users of the system 100.

The gamified scenario 450 further includes one or more actionable elements 182. An actionable element 182 may be configured to provide details of the financial model 264 to the borrower 230 for the borrower 230 to implement. In an embodiment, the configuration of the actionable elements 182 may provide permissions for the system 100 to autonomously implement the financial model 264, or share details of the financial model 264 with one or more non-users of the system 100, e.g. as a progress report 260 or a summary report 270, as will be described in more detail herein.

In an embodiment, the gamified scenario 450 is dynamically updatable. Accordingly, the borrower 230 or the lender 220 can modify one or more features of the gamified scenario 450 such as amending the future credit score 420 to a greater or lesser amount, or amending the financial model, e.g. the amounts to be paid, or the accounts included in the financial model. Amendments to the gamified scenario 450 by borrower 230 or the lender 220 will send and receive instructions to and from the borrower device 230 or the lender device 220 to the system 100. The system 100 will then amend the gamified scenario 450 and/or financial model 264 to reflect these changes.

### Credit Score Estimation Based on Gamified Scenario

The system 100 provides a financial model 264 whereby carrying out the actions as directed in the financial model 264, increases the probability of achieving the future credit score 420 within a given time period, e.g. 30 days. The progress report logic 160 can monitor progress towards the future score 420 by monitoring a change in the borrower's current credit score 418 over time. The progress report logic 160 generates the progress report 260 that may be shared with the borrower 230, the lender 220, or be included as part of a summary report 270.

FIG. 4 shows an exemplary embodiment of the summary report 270, which may include information associated with the progress report 260. The summary report 270 may include details of the gamified scenario 450, future credit score 420, benefits 460, and the like. The progress report 260 includes details of changes to the borrower's current credit score 418 over time 272, and extrapolates a projected progress 274 towards the future credit score 420. In an embodiment, the progress report 260 can include an interactive graphic, chart, or the like, although other tabular, graphical, or written reports are also contemplated.

The progress report logic 160 can then determine i) whether the actions 266 of the financial model are being carried out in compliance with the details of action set forth in the financial model 120, and ii) whether the actions 266 are having the predicted effect on the borrowers credit score, sufficient to achieve the future credit score 420 within the predetermined time. For example, the actions 266 of the financial model 264 could be implemented incorrectly, such as a lesser amount than indicated was paid, or the amount was paid at an incorrect time. Alternatively, the actions were carried out correctly, however, the effect on the borrower's credit score were less than predicted by the financial model. As such the current credit score 418 could be less than expected and the projected progress 274 could fail to achieve the future credit score, e.g. at day=30.

Alternatively, additional actions could have been carried out, such as additional funds paid to an account, or the actions 266 could have a greater effect on the credit score than predicted. As such the future credit score could be achieved ahead of time. In either example, progress report logic 160 can monitor the change in the borrower's credit score over time, and notify the borrower 230 and/or lender 220 if the financial model is being implemented correctly based on the changes in credit score. Any deviation from the predicted credit score can be notified to the borrower 230 or the lender 220 and the financial model 264 can be modified accordingly.

In an embodiment, the summary report logic 170 can provide the summary report 270 including details of the financial model 264, the target credit score 420, progress towards the target credit score 420, or a summary of benefits, goods, or services achievable 460 with the target credit score. The summary report 270 can be provided to the borrower(s) 230, the lender(s) 220 or a combination thereof. In an embodiment, the summary report 270 can be provided as an access link to a digitally rendered modifiable image.

Advantageously, the system 100 can allow a borrower 230 and a lender 220 to determine a future credit score on day 1 and the system 100 can provide a financial model that will achieve the future credit score within a predetermined time frame, e.g. by day 30. This allows the lender 220 to provide a loan on day 1, using the future credit score 420 that will be achieved by day 30. As such, by the time the loan is funded, e.g. on day 30, the current credit score 418 for the borrower 230 will be the same as the future credit score when the loan that was initiated on day 1. The system 100 can allow a borrower 230 to borrow on more favorable loan rates, as well as motivating the borrower 230 to achieve the future credit score 230 within a predetermined time frame and providing a clear course of action in order to achieve the future credit score 230.

### System Enrollment Scheme

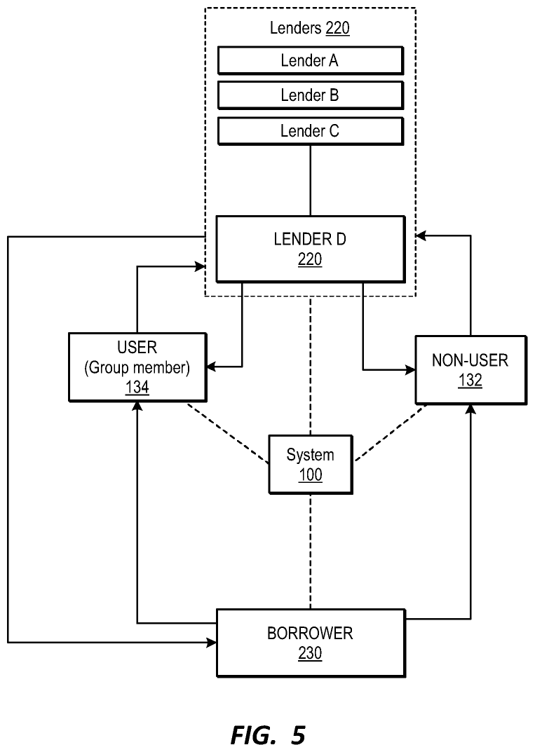

FIG. 5 shows an exemplary enrollment process for the system 100. According to one embodiment of the disclosure, the system 100 can provide access to a plurality of users such as, for example, the first user 220 operating as a mortgage broker or lender and the second user 230 operating as a borrower. The lender 220 can send a request to the system 100 to generate a gamified scenario, including a financial model, as described herein. The lender 220 can then share the gamified scenario with the borrower 230 to indicate how the borrower 230 could achieve a future credit score 420 within a predetermined time window if the actions of the financial model 264 are implemented.

Advantageously, the lender 220 can use the gamified scenario 264 to collaborate with the borrower 230 to illustrate the savings that can be achieved when using the borrower's future credit score 420, on condition that the financial model 264 is implemented. The lender 220 can then start the loan process based on the future credit score 420, prior to the future credit score 420 being achieved and based on iterative credit score feedback through progress reports generated by completion or omission of certain actions by the borrower 230 set forth in the financial model 264.

It will be appreciated that the borrower 230 may not initially be enrolled into the system 100. However, once shown the personalized gamified scenario 450, and associated advantages, the borrower 230 would be motivated to enroll and proceed with the lender 220. This contrasts with current methods where lenders can only generically promise such advantages without any tangible plans to substantiate the promises. The tangible plans are realized by generation of the financial model that allows for funding of loans according to a higher future credit score, which allows the borrower 230 to realize better loan terms (e.g., lower interest rates, lower penalty fees, etc.) while mitigating risk for the lender 220 (monitored credit score changes to ensure an achievable future credit score or lower credit score that may be subject to the same loan terms).

In an embodiment, summary report logic 170 can provide a summary report 270 that the borrower 230 can share, using a share link provided with the summary report, with a non-user 132 of the system, or with another user 134 of the system to show what the lender 220 has achieved for the borrower 230. For example, the non-user 132 or other user 134 may be a friend, colleague, acquaintance, etc. of the borrower 230. In an embodiment, the other user 134 of the system may not be directly known to the borrower 230 but may belong to a similar grouping as the borrower 230, as determined by the group selection logic 190. The other user 134 may belong to a similar socio-economic or demographic group as the borrower 230, or may work for the same employer as the borrower 230. As such, the non-user 132 or other user 134 may identify with the borrower 230 in some way. The summary report 270 can be generated and shared either before or after the future score has been achieved. The non-user 132 or other user 134 is also provided a second link, e.g. a lender link, to access the lender 220 and request a similar service performed using their information. The lender 220 then enters the information about the non-user 132/user 134 into the system 100 and the process repeats with the non-user 132/user 134 becoming the borrower 230.

In an embodiment, the lender 220 can share the summary report 270 with a non-user 132/user 134 to show what the lender 220 has achieved for the borrower 230. The non-user 132/user 134 is provided a lender link with the lender 220 to request a similar service performed using their information. The lender 220 then enters the information about the non-user 132/user 134 to the system 100 and the process repeats with the non-user 132/user 134 becoming the borrower 230.

### Underwriting Selection and Monitoring

Continuing the exemplary process as shown in FIG. 5, in an embodiment, the summary report 270 that is shared with a third user, e.g. the non-user 132 or the user/group member 134, and further includes an access link to provide the third user 132, 134 with access to the system 100 to generate a gamified scenario, as described herein, using the third user's information. Advantageously, the third user can be motivated to enroll with the system 100 based on the benefits and advantages achieved for the borrower 230. Further, there is an increased level of trust between the third user and the system 100, not only from the proven results with the borrower 230 but also from receiving a recommendation from familiar contact, i.e. borrower 230.

Once the third user 132, 134 has implemented the gamified scenario, the lender selection logic 180 can be triggered to send requests to one or more lenders 220, e.g. Lenders A-D requesting loan details based on the future credit score 420 of the gamified scenario 450. The lender selection logic 180 can then match the most favorable offer from the one or more lenders 220, e.g. Lender D, with the third user 132, 134. Lender D then enrolls the third user 132, 134, who them becomes the borrower 230 and the process repeats.

In an embodiment, one or more of the lenders A-D 220 are already subscribed with the system 100. The lender selection logic 180 then queries the data store 151 to retrieve the details of the lenders 220 and sends requests to each of the lenders 220 for loan details based on the future score 420 of the gamified scenario 450.

In an embodiment, one or more of the lenders 220 are not subscribed with the system 100. The lender selection logic 180 then queries a third party data store 130 to retrieve the details of the lenders 220 and sends requests to each of the lenders 220 for loan details based on the future score 420. The selected lender, e.g. lender D, then subscribes to the system to be provided access to the third user 132, 134, and the gamified scenario 264 and financial model 264 that will achieve the future score 420.

Advantageously, the borrower 230 and/or third user 132, 134 can promote the system 100 to other lenders who are not subscribed with the system 100. Further, the other lenders A-D 220 are motivated to subscribe to the system 100 to lend to borrowers who have a higher credit score, albeit a future credit score, which the borrower is already motivated to achieve, therefore mitigating the risk to the lender 220.

### Bulk Underwriting

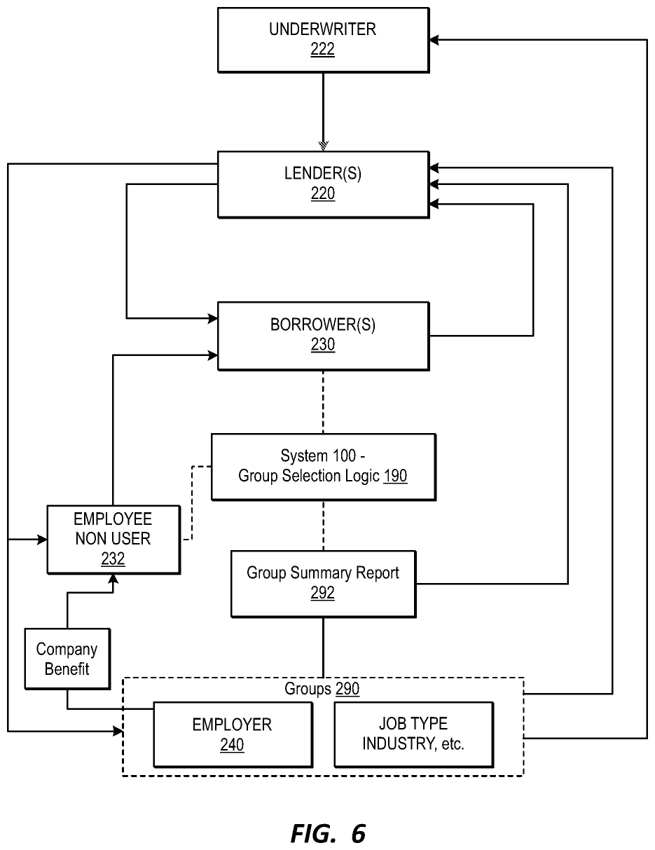

As shown in FIG. 6. in an embodiment, the group selection logic 190 retrieves information from the data store 151 and third party data store 130, and identifies one or more borrowers 230 that belong to a common group, e.g. employer, job type, industry, geographic area, socio-demographic group, or the like. The group selection logic 190 then aggregates previously generated gamified scenarios 450, financial models 264, progress reports 260, summary reports 270, or combinations thereof, which were generated for the borrowers 230 of the group 290, and provides a group summary report 292. e.g. “50 users of [the group] averaged an 80 point increase to their credit score within 30 days.”

In an embodiment, the group selection logic 190 can share the group summary report 292 with a lender 220. The lender 220 can then determine a favorable loan for the group as a whole based on groups future score 420. In an embodiment, the lender 220 can determine a favorable loan for the group based on only a percentage of the group achieving the future score. In an embodiment, the members of the group 290 are all employees for a particular company. The lender 220 can then share the group summary report 292 with the employer 240 and/or employees 232, along with the loan rates that are tailored for the employees 232, contingent on the employees 232 achieving the future score. In an embodiment, the system 100 tailors the future score to each of the group members. The employees 232 then enroll to the system 100 through the lender 220 to access the financial model 264 that allows them to achieve the future credit score 420 and subsequent favorable loan rates provided by the lender 220, i.e. the employee 232 becomes the borrower 230.

In an embodiment, the group selection logic 190 can share the group summary report 292 with an employer 240. e.g. “We identified 50 of your employees who averaged a 50 point increase in 30 days, imagine what we can do for the rest of your employees!” The employer 240 can share the group summary report 292 with employees who are non-users 232 of the system 100, for example as a company benefit, or the like. The group summary report 292 can include a link to allow the non-user employees 232 to enroll with the system 100, as described herein.

In an embodiment, the non-user employees 232 can access the system 100 and generate a gamified scenario, as described herein. The lender selection logic 180 can the select a lender 220 to pair with the non-user employee 232, as described herein. The selected lender, e.g. lender D, can enroll the non-user employee 232 to become the borrower 230. In an embodiment, where the selected lender, e.g. lender D, is not already subscribed with the system 100, the lender D can subscribe to the system 100 to access the gamified scenario 264 and enroll the non-user employee 232.

In an embodiment, the group selection logic 190 can trigger the lender selection logic 180 to share the group summary report 292 with one or more lenders 220. In an embodiment, the lender selection logic 180 can share the group summary report 292 with one or more underwriters 222. The group summary report 292 can include aggregated details of the current credit scores 418, and the future credit scores for the group members. e.g. “We identified 60 borrowers who belong to [Group: Employer, Job Type; Industry, Geographic Area, etc.] who have a current credit score of above 700 and a potential future score of +50 points!”

In an embodiment, the one or more lenders 220, then submit bids to the system 100 including a proposed group loan rate. The lender selection logic 180 then selects the most favorable bid and shares the details of the group members with the lender 220 to enroll members of the group and provide a loan contingent on the group members achieving the future credit score by implementing the financial model 264. In an embodiment, a percentage of the group members need only achieve the future credit score in order for the loan rates to be provided to all of the group members.

In an embodiment, the underwriter 222 with the winning bid can then provide the loan to one or more lenders 220 on the condition that the borrower both belongs to the group specified in the group summary report 292, and uses the system 100 to improve their credit score, as detailed in the group summary report 292. Advantageously, the group members are provided more favorable loan rates from the underwriter 222 via the lender 220.

Advantageously, the lender 220/underwriter 222 is provided bulk enrollment of new borrowers, and the group members take advantage of lower group rates on a loan, contingent on achieving the future credit score 420.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. For example, specific examples or features are provided; however, embodiments include those variations obvious to a person skilled in the art, such as combining features together. Further, while some specific embodiments of the invention have been shown the invention is not to be limited to these embodiments. For example, several specific modules have been shown. Each module performs a few specific functions. However, all of these functions could be grouped into one module or even broken down further into scores of modules. Most functions performed by electronic hardware components may be duplicated by software emulation and vice versa. The invention is to be understood as not limited by the specific embodiments described herein, but only by scope of the appended claims.

While the invention has been described in terms of particular variations and illustrative figures, those of ordinary skill in the art will recognize that the invention is not limited to the variations or figures described. The features described with respect to one embodiment or variation may be used in other embodiments or variations. Processes described separately may be combined. In addition, where processes and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

1. A method for enrolling users to a system, comprising:
responsive to information received from a first user, generating a first gamified user interface for:
i) depicting a first credit score and information associated with a second user; and
ii) selecting a second credit score;
wherein the first gamified user interface includes a digitally rendered modifiable image;
conducting analytics on the information associated with the second user in accordance with one or more predetermined rule sets to generate a credit modification model, wherein the information associated with the second user includes personally identifiable information or financial data;
wherein conducting analytics includes determination of operations of the credit modification model to modify a credit score associated with the second user from the first credit score to the second credit score;
generating a second gamified user interface depicting the second credit score, and displaying a proposed change to the information associated with the second user;
responsive to detecting a selection of an actionable display element rendered as part of the second gamified user interface, transmitting the one or more messages to a destination, the transmission of the message resulting in an implementation of the operations of the credit modification model to modify the credit score associated with the second user from the first credit score to the second credit score; and
conducting analytics on a change in the credit score associated with the second user over time to provide a progress report.

2. The method according to claim 1, further including providing access to the gamified user interface to the second user, and sending and receiving information from one of the first user or the second user that causes generating a second gamified user interface.

3. The method according to claim 1, further including generating a summary report that includes one of the first credit score, the second credit score, the credit modification model, or the progress report.

4. The method according to claim 3, further including removing any personally identifiable information from the summary report and providing a share link to one of the first user or the second user to share the summary report with a third user.

5. The method according to claim 4, wherein the first user is a first lender, the second user is a first borrower, and the third user is one of a second borrower or a second lender.

6. The method according to claim 4, further including providing a second share link to the third user to provide access to the third user to generate a third gamified user interface, including a third credit modification model, using information associated with the third user.

7. The method according to claim 4, retrieving information from one or more lenders and information of one or more loans and conducting analytics to match a loan with the third credit modification model.

8. The method according to claim 1, further including conducting analytics on the information associated with the second user to determine membership to a group, aggregating information from one or more members of the group to create a group summary report, and providing access to the group summary report to one of an underwriter, a lender, or an employer of the group members.

9. The method according to claim 8, wherein information from the one or more members of the group includes one of a first credit score, a second credit score, a credit modification model, or a progress report.

10. The method according to claim 1, further including responsive to detecting a selection of an actionable display element rendered as part of the second gamified user interface transmitting the one or more messages to a destination further includes initiating a loan for the second user based on the second credit score, the loan being funded when the second user achieves the second credit score.

11. A non-transitory computer readable medium which, when read by a processor, causes the processor to execute:
a gamified scenario logic configured to receive information from a first user and to generate a first gamified user interface including depicting a first credit score and information associated with a second user; and selecting a second credit score, wherein the first gamified user interface includes a digitally rendered modifiable image;
a financial model logic configured to conduct analytics on the information associated with the second user in accordance with one or more predetermined rule sets to generate a credit modification model, wherein the information associated with the second user includes personally identifiable information or financial data, and wherein conducting analytics includes determination of operations of the credit modification model to modify a credit score associated with the second user from the first credit score to the second credit score; and
a progress report logic configured to conduct analytics on a change in the credit score associated with the second user over time to provide a progress report.

12. The non-transitory computer readable medium according to claim 11, wherein the gamified scenario logic is further configured to provide access to the gamified user interface to the second user, and send and receive information from one of the first user or the second user that causes generating a second gamified user interface.

13. The non-transitory computer readable medium according to claim 11, further including a summary report logic configured to generate a summary report that includes one of the first credit score, the second credit score, the credit modification model, or the progress report.

14. The non-transitory computer readable medium according to claim 13, wherein the summary report logic is further configured to remove any personally identifiable information from the summary report and provide a share link to one of the first user or the second user to share the summary report with a third user.

15. The non-transitory computer readable medium according to claim 14, wherein the first user is a first lender, the second user is a first borrower, and the third user is one of a second borrower or a second lender.

16. The non-transitory computer readable medium according to claim 14, wherein the summary report logic is further configured to provide a second share link to the third user to provide access to the third user to generate a third gamified user interface, including a third credit modification model, using information associated with the third user.

17. The non-transitory computer readable medium according to claim 16, further including a lender selection logic configured to retrieve information from one or more lenders and information of one or more loans and conduct analytics to match a loan with the third credit modification model.

18. The non-transitory computer readable medium according to claim 11, further including a group selection logic configured to conduct analytics on the information associated with the second user to determine membership to a group, aggregating information from one or more members of the group to create a group summary report, and providing access to the group summary report to one of an underwriter, a lender, or an employer of the group members.

19. The non-transitory computer readable medium according to claim 18, wherein information from the one or more members of the group includes one of a first credit score, a second credit score, a credit modification model, or a progress report.

20. The non-transitory computer readable medium according to claim 11, wherein the gamified scenario logic is configured to detect selection of an actionable display element rendered as part of the first gamified user interface and transmit one or more messages to a destination, the one or more messages includes initiating a loan for the second user based on the second credit score, the loan being funded when the second user achieves the second credit score.

21. A network device, comprising:
a processor; and
memory communicatively coupled to the processor, the memory comprising machine readable instructions that when executed by the processor, cause the processor to execute:
i) a gamified scenario logic configured to receive information from a first user and to generate a first gamified user interface including depicting a first credit score and information associated with a second user, and selecting a second credit score, wherein the first gamified user interface includes a digitally rendered modifiable image;
ii) a financial model logic configured to conduct analytics on the information associated with the second user in accordance with one or more predetermined rule sets to generate a credit modification model, wherein the information associated with the second user includes personally identifiable information or financial data, wherein conducting analytics includes determination of operations of the credit modification model to modify a credit score associated with the second user from the first credit score to the second credit score; and
iii) a progress report logic configured to conduct analytics on a change in the credit score associated with the second user over time to provide a progress report.

22. The network device according to claim 21, wherein the gamified scenario logic is configured to detect selection of an actionable display element rendered as part of the first gamified user interface and transmit one or more messages to a destination, the one or more messages includes initiating a loan for the second user based on the second credit score, the loan being funded when the second user achieves the second credit score.
